(19) United States
(12) Patent Application Publication
(10) Pub. No.: US 2026/0322446 A1
(43) Pub. Date: Oct. 15, 2026

(54) METHODS AND APPARATUS OF CSI REPORTING ON AMPLITUDE AND PHASE COEFFICIENTS FOR COHERENT JOINT TRANSMISSION

(71) Applicant: Lenovo (Beijing) Limited, Beijing (CN)

(72) Inventors: Yi Zhang, Beijing (CN); Chenxi Zhu, Beijing (CN); Wei Ling, Beijing (CN); Bingchao Liu, Beijing (CN); Lingling Xiao, Beijing (CN)

(73) Assignee: Lenovo (Beijing) Limited, Beijing (CN)

(21) Appl. No.: 19/108,313

(22) PCT Filed: Sep. 28, 2022
(86) PCT No.: PCT/CN2022/122190

§ 371 Date: Mar. 3, 2025

(51) Int. Cl. H04B 7/06

(52) U.S. Cl. CPC H04B 7/0626

(57) ABSTRACT

Methods and apparatus of CSI reporting on amplitude and phase coefficients for coherent joint transmission are disclosed. The apparatus includes a receiver that receives a configuration signalling for a Channel State Information (CSI) report based on a codebook for coherent joint transmission (CJT) with a plurality of transmitting-receiving identities; and a transmitter that transmits the CSI report with amplitude coefficients and/or phase coefficients based on the codebook.

### FIELD

The subject matter disclosed herein relates generally to wireless communication and more particularly relates to, but not limited to, methods and apparatus of Channel State Information (CSI) reporting on amplitude and phase coefficients for coherent joint transmission (CJT).

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Channel State Information (CSI), Channel State Information Reference Signal (CSI-RS), Frequency Division Duplex (FDD), Frequency Division Multiple Access (FDMA), Index/Identifier (ID), Multiple Input Multiple Output (MIMO), Phase-shift keying (PSK), Reference Signal (RS), Reference Signal Received Power (RSRP), Sounding Reference Signal (SRS), Time-Division Duplexing (TDD), Transmission Reception Point (TRP), Uplink Control Information (UCI), Frequency Range 1 (FR1), Frequency Range 2 (FR2), Precoder Matrix Indicator (PMI), Rank Indicator (RI), Technical Specification (TS), Universal Terrestrial Radio Access Network (UTRAN), Non-Zero Power CSI-RS (NZP CSI-RS), Full Duplex (FD), Coherent Joint Transmission (CJT), Joint Transmission (JT), Non-Coherent Joint Transmission (NC-JT), Channel Measurement Resource (CMR).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

In Release 18 of 3GPP specifications, enhancements on both downlink and uplink MIMO that facilitate the use of large antenna array, for both FR1 and FR2, are needed to fulfil the demand for evolution of NR deployments.

As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

In coherent joint transmission (CJT), a CSI report is associated with a plurality of CSI-RS resources from channel measurement resources. Accordingly, in the present disclosure, the term CJT may also be referred to as “one CSI report is associated with a plurality of CSI-RS resources from channel measurement resources”. Transmission from one TRP may also be referred to as “a transmission with corresponding CSI report associated with the one Non-Zero Power CSI-RS (NZP CSI-RS) in the configured Channel Measurement Resource (CMR)”.

### SUMMARY

Methods and apparatus of CSI reporting on amplitude and phase coefficients for coherent joint transmission are disclosed.

According to a first aspect, there is provided an apparatus, including: a receiver that receives a configuration signalling for a Channel State Information (CSI) report based on a codebook for coherent joint transmission (CJT) with a plurality of transmitting-receiving identities; and a transmitter that transmits the CSI report with amplitude coefficients and/or phase coefficients based on the codebook.

According to a second aspect, there is provided an apparatus, including: a transmitter that transmits a configuration signalling for a Channel State Information (CSI) report based on a codebook for coherent joint transmission (CJT) with a plurality of transmitting-receiving identities; and a receiver that receives the CSI report with amplitude coefficients and/or phase coefficients based on the codebook.

According to a third aspect, there is provided a method, including: receiving, by a receiver, a configuration signalling for a Channel State Information (CSI) report based on a codebook for coherent joint transmission (CJT) with a plurality of transmitting-receiving identities; and transmitting, by a transmitter, the CSI report with amplitude coefficients and/or phase coefficients based on the codebook.

According to a fourth aspect, there is provided a method, including: transmitting, by a transmitter, a configuration signalling for a Channel State Information (CSI) report based on a codebook for coherent joint transmission (CJT) with a plurality of transmitting-receiving identities; and receiving, by a receiver, the CSI report with amplitude coefficients and/or phase coefficients based on the codebook.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a flow chart illustrating steps of CSI reporting on amplitude and phase coefficients for coherent joint transmission by UE in accordance with some implementations of the present disclosure; and

FIG. 5 is a flow chart illustrating steps of CSI reporting on amplitude and phase coefficients for coherent joint transmission by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

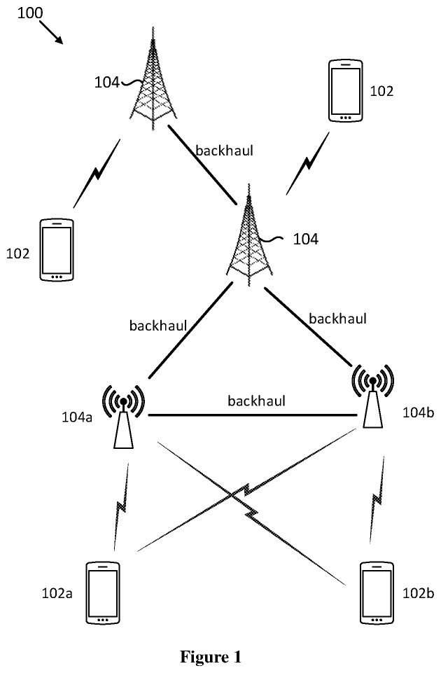

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

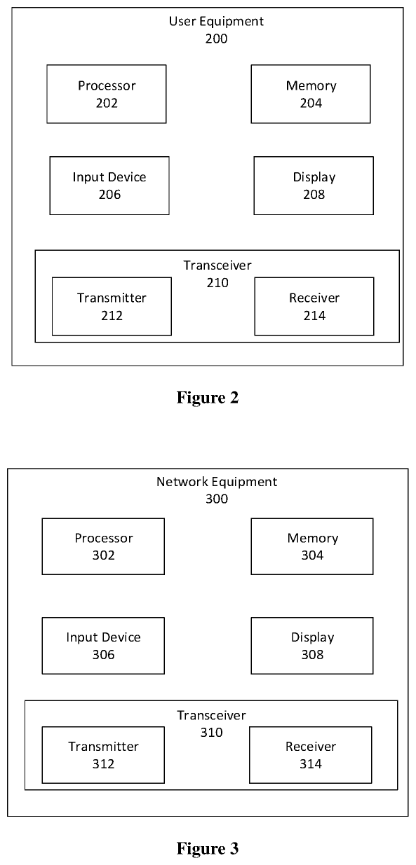

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

It is important to identify and specify necessary enhancements for both downlink and uplink MIMO for facilitating the use of large antenna array, not only for FR1 but also for FR2, to fulfil the request for evolution of NR deployments in Release 18. In Release 16 or 17, features for facilitating multi-TRP deployments have been introduced focusing on non-coherent joint transmission (NC-JT). As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

In Release 18, coherent joint transmission will be further enhanced, where the same information may be transmitted coherently from multiple TRPs. For CSI reports for CJT, the overhead is larger since UE needs to report CSI for serving cell and cooperative cells. A maximum of 4 TRPs and a maximum RI value of 4 may be used for CJT transmission. In the present disclosure, enhanced amplitude and phase coefficient reporting schemes are proposed for CJT based on two agreed codebook structures.

In RAN1 #110 meeting, the following agreements are made for CSI for CJT, which may serve as working assumptions for potential CSI reporting overhead reduction schemes:
For the Rel-18 Type-II codebook refinement for CJT mTRP with N_{TRP}>1 TRP/TRP-groups, support N_{TRP}={1, 2, 3, 4} with equal priority.
For the Rel-18 Type-II codebook for CJT mTRP, support RI={1,2,3,4}.
For the Rel-18 Type-II codebook refinement for CJT mTRP with N_{TRP}>1 TRP/TRP-groups, the following is supported:
   The CMR comprises K>1 NZP CSI-RS resources, where one resource corresponds to one TRP/TRP-group (i.e. K=N_{TRP})
      Each of the CSI-RS resources has a same number of CSI-RS ports
For the Rel-18 Type-II codebook for CJT mTRP, support the following two modes:
   Mode 1: Per-TRP/TRP-group SD/FD basis selection which allows independent FD basis selection across N TRPs/TRP groups. Example formulation (N=number of TRPs or TRP groups):

$$[ \begin{matrix}\begin{matrix}{W}_{1 , 1} {\tilde{W}}_{2 , 1} {W}_{f , 1}^{H} \\ ⋮\end{matrix} \\ {W}_{1 , N} {\tilde{W}}_{2 , N} {W}_{f , N}^{H}\end{matrix} ]$$

Mode 2: Per-TRP/TRP group (port-group or resource) SD basis selection and joint/common (across N TRPs) FD basis selection. Example formulation (N=number of TRPs or TRP groups):

$$[ \begin{matrix}\begin{matrix}{W}_{1 , 1} {\tilde{W}}_{2 , 1} {W}_{f}^{H} \\ ⋮\end{matrix} \\ {W}_{1 , N} {\tilde{W}}_{2 , N} {W}_{f}^{H}\end{matrix} ]$$

Striving for the two modes to share commonality in detailed designs such as parameter combinations, basis selection, TRP (group) selection, reference amplitude, W₂ quantization schemes.

For Release 16 e-Type2 codebook, the CSI reporting scheme for amplitude and phase coefficients is specified as follows in Technical Specification (TS) 38.214.

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’
The values of N₁ and N₂ are configured with the higher layer parameter n1-n2-codebookSubsetRestriction-r16. The supported configurations of (N₁, N₂) for a given number of CSI-RS ports and the corresponding values of (O₁, O₂) are given in Table 5.2.2.2.1-2. The number of CSI-RS ports, P_{CSI-RS}, is 2N₁N₂.
The values of L, β and p_{ν} are determined by the higher layer parameter paramCombination-r16, where the mapping is given in Table 5.2.2.2.5-1.
   The UE is not expected to be configured with paramCombination-r16 equal to
      3, 4, 5, 6, 7, or 8 when P_{CSI-RS}=4.
      7 or 8 when P_{CSI-RS}<32
      7 or 8 when higher layer parameter typeII-RI-Restriction-r16 is configured with rᵢ=1 for any i>1.
      7 or 8 when R=2.
The parameter R is configured with the higher-layer parameter numberOfPMI-SubbandsPerCQI-Subband. This parameter controls the total number of precoding matrices N₃ indicated by the PMI as a function of the number of configured subbands in csi-ReportingBand, the subband size configured by the higher-level parameter subbandSize and of the total number of PRBs in the bandwidth part according to Table 5.2.1.4-2.

TABLE 5.2.2.2.5-1
Codebook parameter configurations for L, β and p_{υ}

| paramCombination- | | P_{υ} | | |
|---|---|---|---|---|
| r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value ν according to the configured higher layer parameter typeII-RI-Restriction-r16. The UE shall not report ν>4.
   The amplitude coefficient indicators i_{2,3,l} and i_{2,4,l} are

$${i}_{2 , 3 , l} = [ {k}_{l , 0}^{( 1 )} {k}_{l , 1}^{( 1 )} ]$$

$${i}_{2 , 4 , l} = [ {k}_{l , 0}^{( 2 )} … {k}_{l , {M}_{υ} - 1}^{( 2 )} ]$$

$${k}_{l , f}^{( 2 )} = [ {k}_{l , 0 , f}^{( 2 )} … {k}_{l , 2 L - 1 , f}^{( 2 )} ]$$

$${k}_{l , p}^{( 1 )} ∈ \{ 1 , … , 15 \}$$

$${k}_{l , i , f}^{( 2 )} ∈ \{ 0 , … , 7 \}$$

for l=1, . . . , ν.
The phase coefficient indicator i_{2,5,l} is

$${i}_{2 , 5 , l} = [ {c}_{l , 0} … {c}_{l , {M}_{υ} - 1} ]$$

$${c}_{l , f} = [ {c}_{l , 0 , f} … {c}_{l , 2 L - 1 , f} ]$$

$${c}_{l , i , f} ∈ \{ 0 , … , 15 \}$$

for l=1, . . . , ν.
Let K₀=┌β2LM₁┐. The bitmap whose nonzero bits identify which coefficients in i_{2,4,l} and i_{2,5,l} are reported, is indicated by i_{1,7,l}

$${i}_{1 , 7 , l} = [ {k}_{l , 0}^{( 3 )} … {k}_{l , {M}_{υ} - 1}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} ∈ \{ 0 , 1 \}$$

for l=1, . . . , ν, such that

$${K}_{l}^{NZ} = {\sum }_{i = 0}^{2 L - 1} {\sum }_{f = 0}^{{M}_{υ} - 1} {k}_{l , i , f}^{( 3 )} \leq {K}_{0}$$

is the number of nonzero coefficients for layer l=1, . . . , ν and

$${K}^{NZ} = {\sum }_{l = 1}^{υ} {K}_{l}^{NZ} \leq 2 {K}_{0}$$

is the total number of nonzero coefficients.
The indices of i_{2,4,l}, i_{2,5,l} and i_{1,7,l} are associated to the M_{ν} codebook indices in n_{3,l}.
The mapping from

$${k}_{l , p}^{( 1 )}$$

to the amplitude coefficient

$${p}_{l , p}^{( 1 )}$$

is given in Table 5.2.2.2.5-2 and the mapping from

$${k}_{l , i , f}^{( 2 )}$$

to the amplitude coefficient

$${p}_{l , i , f}^{( 2 )}$$

is given in Table 5.2.2.2.5-3. The amplitude coefficients are represented by

$${p}_{l}^{( 1 )} = [ {p}_{l , 0}^{( 1 )} {p}_{l , 1}^{( 1 )} ]$$

$${p}_{l}^{( 2 )} = [ {p}_{l , 0}^{( 2 )} … {p}_{l , {M}_{υ} - 1}^{( 2 )} ]$$

$${p}_{l , f}^{( 2 )} = [ {p}_{l , 0 , f}^{( 2 )} … {p}_{l , 2 L - 1 , f}^{( 2 )} ]$$

for l=1, . . . , ν.

### Let

$${f}_{l}^{*} ∈ \{ 0 , 1 , … , {M}_{υ} - 1 \}$$

be the index of i_{2,4,l} and

$${i}_{l}^{*} ∈ \{ 0 , 1 , … , 2 L - 1 \}$$

be the index of

$${k}_{l , {f}_{l}^{*}}^{( 2 )}$$

which identify the strongest coefficient of layer l, i.e., the element

$${k}_{l , {i}_{l}^{*} , {f}_{l}^{*}}^{( 2 )} of {i}_{2 , 4 , l} ,$$

for l=1, . . . , ν. The codebook indices of n_{3,l} are remapped with respect to

$${n}_{3 , l}^{( {f}_{l}^{*} )}$$

as

$${n}_{3 , l}^{( f )} = ( {n}_{3 , l}^{( f )} - {n}_{3 , l}^{( {f}_{l}^{*} )} ) mod {N}_{3} ,$$

such that

$${n}_{3 , l}^{( {f}_{l}^{*} )} = 0 ,$$

after remapping. The index f is remapped with respect to

$${f}_{l}^{*} as f = ( f - {f}_{l}^{*} ) mod {M}_{υ} ,$$

such that the index of the strongest coefficient is fₗ*=0 (l=1, . . . , ν), after remapping. The indices of i_{2,4,l}, i_{2,5,l} and i_{1,7,l} indicate amplitude coefficients, phase coefficients and bitmap after remapping. The strongest coefficient of layer l is identified by i_{1,8,l}∈{0, 1, . . . , 2L−1}, which is obtained as follows

$${i}_{1 , 8 , l} = \{ [ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix} ]$$

for l=1, . . . , ν.

TABLE 5.2.2.2.5-2
$Mapping of elements of {i}_{2 , 3 , l} : {k}_{l , p}^{( 1 )} to {p}_{l , p}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | ⅛ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | ¼ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | ½ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{1} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , υ ) .$$

The indicators

$${k}_{l , ⌊ \frac{{i}_{l}^{*}}{L} ⌋}^{( 1 )} , {k}_{l , {i}_{l}^{*} , 0}^{( 2 )} and {c}_{l , {i}_{l}^{*} , 0}$$

are not reported for l=1, . . . , ν.
The indicator

$${k}_{l , ( ⌊ \frac{{i}_{l}^{*}}{L} ⌋ + 1 ) mod 2}^{( 1 )}$$

is reported for l=1, . . . , ν.
The K^{NZ}−ν indicators

$${k}_{l , i , f}^{( 2 )}$$

for which

$${k}_{l , i , f}^{( 3 )} = 1 , i \neq {i}_{l}^{*} ,$$

f≠0 are reported.
The K^{NZ}−ν indicators c_{l,i,f} for which

$${k}_{l , i , f}^{( 3 )} = 1 , i \neq {i}_{l}^{*} ,$$

f≠0 are reported.
The remaining 2L Mᵥ·v−K^{NZ} indicators

$${k}_{l , i , f}^{( 2 )}$$

are not reported.
The remaining 2L·Mᵥ·v−K^{NZ} indicators c_{l,i,f} are not reported.

TABLE 5
$Mapping of elements of {i}_{2 , 4 , l} : {k}_{l , i , f}^{( 2 )} to {p}_{l , i , f}^{( 2 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | ⅛ |
| 2 | $\frac{1}{4 \sqrt{2}}$ |
| 3 | ¼ |
| 4 | $\frac{1}{2 \sqrt{2}}$ |
| 5 | ½ |
| 6 | $\frac{1}{\sqrt{2}}$ |
| 7 | 1 |

For e-Type2 codebook, the amplitude and phase coefficients are designed for single TRP transmission. For CJT, enhanced codebook is designed for CSI reporting for multiple TRPs; and two codebook structures are agreed to be supported in Release 18. The CSI reporting for amplitude and phase coefficients in the case of CJT should be carefully designed based on the two agreed codebook structures.

In the present disclosure, enhanced amplitude coefficient reporting schemes are proposed, including the strongest coefficient quantization scheme for one TRP which takes into consideration of different RSRP values between TRPs on account of different locations; enhanced amplitude coefficient quantization per polarization which introduces ‘0’ value on account of larger pathloss and thus smaller amplitude coefficients for one or two polarizations of some coordinated TRPs; and joint quantization between amplitude coefficient quantization for non-zero elements and strongest coefficient quantization for one TRP.

Enhanced phase coefficient quantization schemes with different precisions are also proposed, such as 16-PSK and 8-PSK for two precisions. The phase coefficients of non-zero elements from TRPs or non-zero element set may be used with different quantization precisions. In this way, CSI reporting overhead may be reduced with tradeoff of system performance. It is useful for the case with high TRP number and/or high rank value.

In the present disclosure, enhanced CSI reporting on amplitude and phase coefficients is proposed to reduce CSI reporting overhead. Based on agreements in RAN1 #110 meeting, two kinds of codebook structures are supported.

For codebook structure Alt.1A (Mode 1), per TRP/TRP-group spatial domain and frequency domain basis independent selection scheme across N TRPs/TRP groups is used.

For codebook structure Alt.2 (Mode 2), per TRP/TRP group spatial domain selection and joint/common frequency domain basis selection across N TRPs are used. The enhanced amplitude and phase coefficient reporting schemes are discussed based on these two agreed codebook structures.

The UE would receive a configuration signalling for a CSI report based on a codebook for CJT with a plurality of TRPs, and subsequently transmit the CSI report with amplitude coefficients and/or phase coefficients based on the codebook. The codebook is enhanced with respect to the legacy codebook, for transmission of enhanced amplitude coefficients and/or enhanced phase coefficients.

### Enhanced CSI Reporting on Amplitude Coefficients

In legacy Release 16 eType2 enhanced codebook, actual non-zero coefficient is indicated by the bitmap by i_{1,7,l}. The amplitude coefficient quantization includes two levels, where the first level is quantization per polarization and the second level is quantization per non-zero coefficient with a differential value based on the first per polarization quantization value. For the first level quantization, the mapping from

$${k}_{l , p}^{( 1 )}$$

to the amplitude coefficient

$${p}_{l , p}^{( 1 )}$$

indicated by i_{2,3,l} is given in Table 5.2.2.2.5-2 in section 5.2.2.5 of TS 38.214. For the second level quantization, the mapping from

$${k}_{l , i , f}^{( 2 )}$$

to the amplitude coefficient

$${p}_{l , i , f}^{( 2 )}$$

indicated by i_{2,4,l} is given in Table 5.2.2.2.5-3 in section 5.2.2.5 of TS 38.214.

Further enhancements for amplitude coefficient reporting are proposed with the following three schemes.

### Scheme 1: Amplitude Coefficient Reporting for the Strongest Coefficient Per TRP

For inter-site CJT transmission, the RSRP values may be different between TRPs on account of different locations. During SRS enhancement for CJT, the cases of pathloss/RSRP difference −3 dB, −6 dB, −10 dB are to be studied. For W2 quantization group, 2N or 2 groups may be used, which correspond to quantization per polarization from one TRP or quantization per polarization across TRPs, respectively.

For codebook structure Alt.1A (Mode 1), 2N quantization groups corresponding to two (2) Polarizations per TRPs may be used. The non-zero coefficient amplitude quantization is made per TRP based on the reference amplitude (i.e., the strongest amplitude) per TRP. Various differential quantization schemes with different quantization precisions may be used for reporting the strongest amplitude coefficient for each TRP, where the strongest amplitude coefficient among TRPs serves as the reference and is assumed the value ‘1’. Similar to the strongest coefficient indication in legacy Release 16 eType2 codebook, the strongest amplitude coefficient for each TRP in this scheme also needs to be quantized per layer. As a simple approach, the quantization may be based on legacy Table 5.2.2.2.5-2, i.e. a mapping table of quantization per polarization for amplitude coefficient indicators

$${i}_{2 , 3 , l} = [ {k}_{l , 0}^{( 1 )} {k}_{l , 1}^{( 1 )} ] ,$$

from

$${k}_{l , p}^{( 1 )}$$

to amplitude coefficient

$${p}_{l , p}^{( 1 )} ,$$

with 4 bits quantization and 1.5 dB step, or legacy Table 5.2.2.2.5-3, i.e. a mapping table of quantization per non-zero coefficient for amplitude coefficient indicators

$${i}_{2 , 4 , l} = [ {k}_{l , 0}^{( 2 )} … {k}_{l , {M}_{υ} - 1}^{( 2 )} ] ,$$

from

$${k}_{l , i , f}^{( 2 )}$$

to amplitude coefficient

$${p}_{l , i , f}^{( 2 )} ,$$

with 3 bits quantization and 3 dB step.

Moreover, newly designed quantization table, such as Table 1a or Table 1b as shown below, may be used based on the assumption that 10 dB RSRP difference between TRPs is used. For the first enhanced approach, it may be quantized with 3 bits quantization and 1.5 dB step but with the quantization range of 12 dB. The detailed quantization table is shown as Table 1a. This mapping table for i_{2,3,l} is an enhanced mapping table comprising eight entries. For the second enhanced approach, it may be quantized with 2 bits quantization and 3 dB step but with the quantization range of 12 dB. The detailed quantization table is shown as Table 1b. This mapping table for i_{2,4,l} is an enhanced mapping table comprising four entries.

The above dB value is derived from power view, which is determined according to the square of amplitude coefficient. The quantization range is determined by the product of quantization step and quantization level number.

TABLE 1A
Amplitude quantization between strongest coefficients among TRPs
with 3 bits enhanced quantization table

| | Quantized Strong coefficient |
|---|---|
| Indicated index | for one TRP |
| 0 | ${( \frac{1}{128} )}^{1 / 4}$ |
| 1 | $\frac{1}{\sqrt{8}}$ |
| 2 | ${( \frac{1}{32} )}^{1 / 4}$ |
| 3 | ½ |
| 4 | ${( \frac{1}{8} )}^{1 / 4}$ |
| 5 | $\frac{1}{\sqrt{2}}$ |
| 6 | ${( \frac{1}{2} )}^{1 / 4}$ |
| 7 | 1 |

TABLE 1b
Amplitude quantization between strongest coefficients among TRPs
with 2 bits enhanced quantization table

| | Quantized Strong coefficient |
|---|---|
| Indicated index | for one TRP |
| 0 | $\frac{1}{2 \sqrt{2}}$ |
| 1 | ½ |
| 2 | $\frac{1}{\sqrt{2}}$ |
| 3 | 1 |

For codebook structure Alt.2 (Mode 2), two (2) quantization groups corresponding to two (2) Polarizations across TRPs may be used. The strongest coefficients among TRPs may serve as the reference amplitude, which may correspond to a reference coefficient, and be assumed the value ‘1’. The quantization for the strongest coefficient per TRP may be implicitly realized in the non-zero coefficient amplitude quantization on the second level. Thus, the legacy Table 5.2.2.2.5-3 in TS 38.214 with 3 bits quantization and 3 dB step may be reused.

The amplitude coefficients may include a strongest coefficient, per layer or across layers, for each TRP. In some examples, the amplitude coefficients may include a reference coefficient for a strongest amplitude among the TRPs, and the strongest coefficient for each TRP is quantized based on a differential value with respect to the reference coefficient.

This scheme may be used for power scaling factor reporting between TRPs if amplitude scaling (or power scaling, just a square of this value) between TRPs is introduced.

### Scheme 2: Enhancement on the First Level Amplitude Coefficient Reporting

For legacy amplitude mapping Table 5.2.2.2.5-2, 21 dB difference between polarization may be supported. It may be assumed that this quantization range is also sufficient in the case of CJT.

In this example, the amplitude coefficients include value ‘0’ for per polarization amplitude coefficient

$${p}_{l , p}^{( 1 )}$$

for a TRP with amplitude smaller than a predefined value.

For multiple TRPs with CJT, the amplitude value per polarization (i.e., the first level amplitude quantization) is related with both TRPs and polarization. For the TRP with lower RSRP value, the amplitude coefficient for weak polarization may be smaller than the current smallest value (i.e., 1/\sqrt{128}). Therefore, the value ‘0’ is introduced and used for the polarization of specific TRP with amplitude value smaller than the existing smallest value. The state ‘0’ for reserved state may be used to indicate value ‘0’.

In this way, the TRP selection and polarization selection may be implicitly realized in the first level amplitude reporting. If the amplitude value is reported as ‘0’, it means no reporting for the corresponding polarization of the TRP.

The dimension of W2 for reporting corresponding to one TRP is reduced to Lₙ×Mᵥ if non-zero amplitude value is only from one polarization of the TRP; and the dimension of W2 for reporting corresponding to one TRP is reduced to 0×0 if amplitude values for both polarizations corresponding to one TRP are ‘0’.

To achieve CSI overhead reduction based on existing framework with two parts CSI reporting, this non-zero amplitude coefficient number across layers and across TRPs needs to be reported in the CSI part 1, which may be used to determine the reporting overhead for CSI part 2. The maximum number is 2N×4=8N, where N is the configured TRP number for CJT, 2 is introduced for two polarizations and 4 is introduced for the maximum of 4 layers. Thus, the indicated bit number is ┌log₂(8N)┐. That is, the CSI report comprises, in CSI part 1, a number of non-zero amplitude coefficients across layers and across TRPs, having ┌log₂(8N)┐ number of bits, where N is configured number of TRPs for CJT.

For CSI part 2, a bitmap indicator per layer may be introduced to further indicate the location of non-zero amplitude coefficient for the polarization of each TRP. The bit number is (2N−1) per layer, where the polarization of one TRP corresponding to the strongest coefficient should always be kept. With this bitmap, the non-zero coefficient location may be accurately resolved. Moreover, the bitmap may be directly indicated in CSI part 1 if the overhead may be acceptable for CSI part 1, especially in the case of a smaller maximum rank value (e.g., rank restriction is used). Then, there is no need for reporting non-zero amplitude coefficient number across layers and across TRPs. That is, the CSI report comprises, in CSI part 1 or CSI part 2, a bitmap per layer to indicate non-zero amplitude coefficients for two polarizations of each TRP, having (2N−1) number of bits per layer, where N is configured number of TRPs for CJT.

### Scheme 3: Enhancement on the Second Level Amplitude Coefficient Reporting

In the third scheme, the legacy scheme for the first level amplitude coefficient quantization may be kept while enhancement for the second level amplitude coefficient quantization may be made.

For the first level amplitude coefficient quantization, amplitude coefficient per polarization is quantized based on the strongest coefficient for each TRP. For the second level amplitude quantization, the strongest coefficient quantization value for one TRP relative to the strongest TRP, or the strongest one among the TRPs, is considered, where the product of strongest coefficient quantization value for this TRP and the second level amplitude quantization value may have a similar quantization range as Release 16 eType2 codebook for one TRP.

For example, when the strongest coefficient quantization for this TRP relative to the strongest TRP is no larger than ⅛, only 1 bit which indicates amplitude value 1 or 1/\sqrt{2} is used for the second level amplitude quantization; when the strongest coefficient quantization for this TRP relative to the strongest TRP is no larger than ¼ but larger than ⅛, only 2 bits which indicate amplitude value 1 or 1/\sqrt{2} or ½ or ½\sqrt{2} are used for the second level amplitude quantization.

For the unused bits or states for the second level amplitude quantization, they may be set as null/padding bits (e.g., fixed as NULL state or bit value 0 in realization) or states and they may be used to improve UCI transmission reliability.

In some examples, the enhanced amplitude coefficients may include amplitude coefficients of non-zero elements that are indicated based on the amplitude of the strongest coefficient per TRP. Upon determining that a quantization value for amplitude coefficient reporting is smaller than a predefined value, corresponding indication states or indication bits in the CSI report are set to predefined values.

### Enhanced CSI Reporting on Phase Coefficients

In legacy Release 16 eType2 enhanced codebook, the non-zero elements in the linear combination matrix are indicated by bitmap matrix. For each nonzero element, the amplitude coefficients and phase coefficients are indicated by i_{2,4,l}, i_{2,5,l}, respectively. For phase coefficients, they are denoted as

$${φ}_{l , i , f} = {e}^{j \frac{2 π {c}_{l , i , f}}{16}} ,$$

which are from 16-PSK symbol set. The indicator for phase coefficient of the strongest coefficient is assumed as 0 (i.e. c_{l,i*}_{ₗ}_{,0}=0) and is not needed for reporting.

For CJT, 1 or N quantization groups may be used for phase quantization, which corresponds to across TRPs or per TRP phase quantization. To save reporting overhead, different phase quantization precisions may be considered especially when CSI reporting overhead is large such as in the cases of large TRP number (e.g. 3 or 4) and/or high rank (e.g. 3 or 4). That is, the phase coefficients may be quantized with two different quantization precisions. The two different quantization precisions may be precisions of 16-PSK quantization and 8-PSK quantization.

In Release 16 eType2 codebook design, 8-PSK and 16-PSK are candidates for phase quantization and 16-PSK has better quantization precision and better performance but with larger overhead. Therefore, to save CSI reporting overhead, 8-PSK may be selected as a low precision quantization scheme and 16-PSK may be selected as a high precision quantization scheme. The phase coefficients of one or more first TRPs, or first set of TRPs, are quantized with a higher precision; and the phase coefficients of one or more second TRPs, or second set of TRPs, are quantized with a lower precision.

Two kinds of schemes are proposed, which may be used to realize phase quantization with different precisions.

TRP Based Phase Quantization Scheme with Different Precisions

For the first kind of schemes, phase of non-zero elements from different TRPs may be quantized with different precisions. It may be better used for CSI reporting based on codebook structure Alt.1A (Mode 1). In the first kind of schemes, the RSRP value from one TRP is used to determine quantization scheme.

For scheme 1, the first TRPs are determined based on RSRP values, or the strongest amplitude coefficient values of the TRPs, or UE reported TRP indexes for the first TRPs. The number of the first TRPs may be set as a predefined value (2 for example), or determined based on a preconfigured threshold, or UE reported value.

In one embodiment, the two TRPs with larger RSRP values may be quantized with 16-PSK and other TRPs with smaller RSRP values may be quantized with 8-PSK. If CSIs for TRPs are concatenated based on the RSRP value and the TRPs with larger RSRP values are put in the first (e.g., the selected beams for TRPs in W1 may be sorted in this way), the phases of non-zero elements from the first two TRPs may be quantized with 16-PSK and those from other TRPs may be quantized with 8-PSK.

In another embodiment, the RSRP value difference between TRPs may be used to determine the quantization precision. For example, when the RSRP difference value between the strongest TRP and one TRP is within a predefined or configured threshold (e.g. 6 dB), 16-PSK quantization is used for phase coefficient quantization for this TRP. Otherwise, 8-PSK quantization is used for phase coefficient quantization for this TRP.

For scheme 2, the value of strongest coefficient of one TRP is used to determine the quantization scheme. In detail, the phase of non-zero elements from two TRPs with larger strongest amplitude coefficient values may be quantized with 16-PSK and the phase of non-zero elements from other TRPs may be quantized with 8-PSK.

In one embodiment, the two TRPs with larger values of the strongest coefficients may be quantized with 16-PSK and other TRPs with smaller values of the strongest coefficients may be quantized with 8-PSK.

In another embodiment, the value of the strongest coefficients difference between TRPs may be used to determine the quantization precision. For example, when the value of the strongest coefficients difference between the strongest TRP and one TRP is within a predefined or configured threshold (e.g. 6 dB), 16-PSK quantization is used for phase coefficient quantization for this TRP. Otherwise, 8-PSK quantization is used for phase coefficient quantization for this TRP.

For this scheme, quantization scheme may be fast changed with channel state information on account of high frequency for the strongest coefficient reporting relative to RSRP reporting.

For scheme 3, UE may determine the TRP number or TRP index with high precision phase quantization for non-zero elements. The UE reports the TRP number or TRP index to gNB, which may be included in part 1 CSI report.

In one embodiment with TRP index indication, it may be realized by bitmap for associated NZP CSI-RS resource for CMR. When the bit corresponding to one TRP is set ‘1’, the phase coefficient corresponding to this TRP is quantized with 16PSK. In another embodiment with TRP number indication, the phasing coefficients corresponding to the x TRPs with higher RSRP values or the larger values for the strongest coefficients may be chosen for high precision phase quantization for non-zero elements when the TRP number x is reported.

Non-Zero Element Set Based Phase Quantization Scheme with Different Precisions

For the second kind of schemes, phase of non-zero elements from different non-zero element sets may be quantized with different precisions. It may be better used for CSI reporting based on codebook structure Alt.2 (Mode 2).

In principle, the first non-zero element set is composed of coefficients with larger amplitude coefficient values and the second non-zero element set is composed of coefficients with smaller amplitude coefficient values. That is, the phase coefficients may include a first coefficient set and a second coefficient set; non-zero elements in the first coefficient set have larger amplitude values than non-zero elements in the second coefficient set; and non-zero elements of the two coefficient sets are quantized with different precisions. For existing information bit mapping scheme, information bits are concatenated based on fields including the amplitude coefficient field i_{2,4,l} and the phase coefficient field i_{2,5,l}. The information bits from the same field are put together. To obtain reported information for phase coefficients, the decoder may firstly obtain amplitude information since the total bit number for amplitude information and phase information may be pre-determined and the location for amplitude information bits and phase information bits can be determined without ambiguity. Then, the decoder may determine the accurate bit number for the phase of each non-zero coefficient according to the value of the amplitude of each non-zero coefficient. Based on this decoding scheme, the decoder may correctly determine the bit number for the phase of each non-zero coefficient and obtain the reported phase information.

In one embodiment, the non-zero element set may be defined per layer and/or across layers. In detail, the number of phase coefficients in the first non-zero element set, or in the first coefficient set, may be

$${K}_{0} = ceil ( {δ}_{1} ⌈ β2 {\sum }_{i = 1}^{N} {L}_{i} {M}_{1} ⌉ )$$

per layer and/or

$$2 {K}_{0} = ceil ( 2 {δ}_{2} ⌈ β2 {\sum }_{i = 1}^{N} {L}_{i} {M}_{1} ⌉ )$$

across lasers, where δ₁ and δ₂ are predefined or high layer configured per-layer ratio or cross-layer ratio, respectively, for non-zero phase coefficients with high precision quantization. For example, δ₁=0.5, δ₂=0.5.

In another embodiment, the number of non-zero coefficients per and/or across layers in the first non-zero element set, or in the first coefficient set, may be a predefined fixed number; or predefined numbers y₁, y₂ that are determined based on selected beam number

$$( i . e . \tilde{L} = {\sum }_{i = 1}^{N} {L}_{i} ) .$$

For example, the predefined values y₁, y₂ may be determined according to Table 2a and Table 2b, which are determined as

$$⌈ β 2 {\sum }_{i = 1}^{N} {L}_{i} {M}_{1} ⌉ , 2 ⌈ β 2 {\sum }_{i = 1}^{N} {L}_{i} {M}_{1} ⌉$$

based on assumptions of M₁=2, β=¼ for high precision quantization, respectively.

If the strongest coefficient is considered with no reporting for the phase coefficient, y may be predetermined value in Table 2a minus 1.

If y is larger than the number of non-zero coefficients per layer indicated by bitmap, the phases of all the non-zero coefficients are quantized with 16-PSK.

TABLE 2a
Predefined non-zero element number per layer for high precision
phase coefficient quantization

| $\tilde{L} = {\sum }_{i = 1}^{N} {L}_{i}$ | y₁ |
|---|---|
| 4 | 4 |
| 5 | 5 |
| 6 | 6 |
| 7 | 7 |
| 8 | 8 |

TABLE 2b
Predefined non-zero element number across layers for high precision
phase coefficient quantization

| $\tilde{L} = {\sum }_{i = 1}^{N} {L}_{i}$ | y₂ |
|---|---|
| 4 | 8 |
| 5 | 10 |
| 6 | 12 |
| 7 | 14 |
| 8 | 16 |

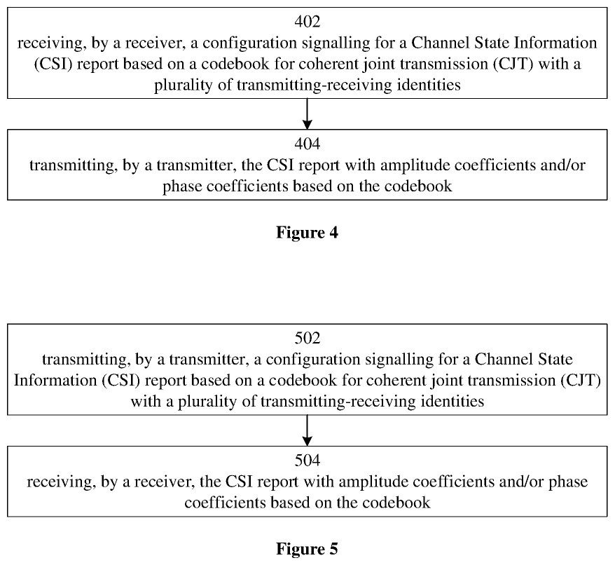

FIG. 4 is a flow chart illustrating steps of CSI reporting on amplitude and phase coefficients for coherent joint transmission by UE 200 in accordance with some implementations of the present disclosure.

At step 402, the receiver 214 of UE 200 receives a configuration signalling for a Channel State Information (CSI) report based on a codebook for coherent joint transmission (CJT) with a plurality of transmitting-receiving identities.

At step 404, the transmitter 212 of UE 200 transmits the CSI report with amplitude coefficients and/or phase coefficients based on the codebook.

FIG. 5 is a flow chart illustrating steps of CSI reporting on amplitude and phase coefficients for coherent joint transmission by gNB 300 in accordance with some implementations of the present disclosure.

At step 502, the transmitter 312 of gNB 300 transmits a configuration signalling for a Channel State Information (CSI) report based on a codebook for coherent joint transmission (CJT) with a plurality of transmitting-receiving identities.

At step 504, the receiver 314 of gNB 300 receives the CSI report with amplitude coefficients and/or phase coefficients based on the codebook.

In one aspect, some items as examples of the disclosure concerning UE may be summarized as follows:

1. An apparatus, comprising:
a receiver that receives a configuration signalling for a Channel State Information (CSI) report based on a codebook for coherent joint transmission (CJT) with a plurality of transmitting-receiving identities; and
a transmitter that transmits the CSI report with amplitude coefficients and/or phase coefficients based on the codebook.

2. The apparatus of item 1, wherein the amplitude coefficients comprise a strongest coefficient, per layer or across layers, for each transmitting-receiving identity.

3. The apparatus of item 2, wherein the amplitude coefficients comprise a reference coefficient for a strongest amplitude among the transmitting-receiving identities, and the strongest coefficient for each transmitting-receiving identity is quantized based on a differential value with respect to the reference coefficient.

4. The apparatus of item 3, wherein the differential value is determined based on a mapping table of quantization per polarization for amplitude coefficient indicators

$${i}_{2 , 3 , l} = [ \begin{matrix}{k}_{l , 0}^{( 1 )} & {k}_{l , 1}^{( 1 )}\end{matrix} ] , from {k}_{l , p}^{( 1 )}$$

to amplitude coefficient

$${p}_{l , p}^{( 1 )} ,$$

or based on a mapping table of quantization per non-zero coefficient for amplitude coefficient indicators

$${i}_{2 , 4 , l} = [ {k}_{l , 0}^{( 2 )} … {k}_{l , {M}_{v} - 1}^{( 2 )} ] , from {k}_{l , i , f}^{( 2 )}$$

to amplitude coefficient

$${p}_{l , i , f}^{( 2 )} .$$

5. The apparatus of item 4, wherein the mapping table for i_{2,3,l} is an enhanced mapping table comprising eight entries, or the mapping table for i_{2,4,l} is an enhanced mapping table comprising four entries.

6. The apparatus of item 1, wherein the amplitude coefficients include value ‘0’ for per polarization amplitude coefficient

$${p}_{l , p}^{( 1 )}$$

for a transmitting-receiving identity with amplitude smaller than a predefined value.

7. The apparatus of item 6, wherein the CSI report comprises, in CSI part 1, a number of non-zero amplitude coefficients across layers and across transmitting-receiving identities, having ┌log₂(8N)┐ number of bits, where N is configured number of transmitting-receiving identities for CJT.

8. The apparatus of item 6, wherein the CSI report comprises, in CSI part 1 or CSI part 2, a bitmap per layer to indicate non-zero amplitude coefficients for two polarizations of each transmitting-receiving identity, having (2N−1) number of bits per layer, where N is configured number of transmitting-receiving identities for CJT.

9. The apparatus of item 1, wherein the amplitude coefficients comprise amplitude coefficients of non-zero elements that are indicated based on the amplitude of the strongest coefficient per transmitting-receiving identity.

10. The apparatus of item 9, wherein, upon determining that a quantization value for amplitude coefficient reporting is smaller than a predefined value, corresponding indication states or indication bits in the CSI report are set to predefined values.

11. The apparatus of item 1, wherein the phase coefficients are quantized with two different quantization precisions.

12. The apparatus of item 11, wherein the two different quantization precisions are precisions of 16-PSK quantization and 8-PSK quantization.

13. The apparatus of item 11, wherein the phase coefficients of one or more first transmitting-receiving identities are quantized with a higher precision; and the phase coefficients of one or more second transmitting-receiving identities are quantized with a lower precision.

14. The apparatus of item 13, wherein the first transmitting-receiving identities are determined based on RSRP values, or the strongest amplitude coefficient values of the transmitting-receiving identities, or UE reported transmitting-receiving identity indexes for the first transmitting-receiving identities.

15. The apparatus of item 14, wherein a number of the first transmitting-receiving identities is set as a predefined value, or determined based on a preconfigured threshold, or UE reported value.

16. The apparatus of item 11, wherein the phase coefficients comprise a first coefficient set and a second coefficient set; non-zero elements in the first coefficient set have larger amplitude values than non-zero elements in the second coefficient set; and non-zero elements of the two coefficient sets are quantized with different precisions.

17. The apparatus of item 17, wherein the first coefficient set includes

$${K}_{0} = {δ}_{1} ⌈ β 2 {\sum }_{i = 1}^{N} {L}_{i} {M}_{1} ⌉$$

per layer, and/or

$$2 {K}_{0} = 2 {δ}_{2} ⌈ β 2 {\sum }_{i = 1}^{N} {L}_{i} {M}_{1} ⌉$$

across layers, number of coefficients, where δ₁ and δ₂ are predefined or high layer configured per-layer ratio and cross-layer ratio, respectively.

18. The apparatus of item 17, wherein the first coefficient set includes a number of coefficients per layer and/or across layers, being a predefined fixed number or predefined numbers y₁, y₂ determined based on selected beam number

$$\tilde{L} = {\sum }_{i = 1}^{N} {L}_{i} ,$$

where Lᵢ is selected beam number for i^{th} transmitting-receiving identity.

19. The apparatus of item 19, wherein the configured value y₁ is the same as \tilde{L} with an assumption of M₁=2, β=¼ and y₂=2y₁.

In another aspect, some items as examples of the disclosure concerning gNB may be summarized as follows:

20. An apparatus, comprising:
a transmitter that transmits a configuration signalling for a Channel State Information (CSI) report based on a codebook for coherent joint transmission (CJT) with a plurality of transmitting-receiving identities; and
a receiver that receives the CSI report with amplitude coefficients and/or phase coefficients based on the codebook.

21. The apparatus of item 20, wherein the amplitude coefficients comprise a strongest coefficient, per layer or across layers, for each transmitting-receiving identity.

22. The apparatus of item 21, wherein the amplitude coefficients comprise a reference coefficient for a strongest amplitude among the transmitting-receiving identities, and the strongest coefficient for each transmitting-receiving identity is quantized based on a differential value with respect to the reference coefficient.

23. The apparatus of item 22, wherein the differential value is determined based on a mapping table of quantization per polarization for amplitude coefficient indicators

$${i}_{2 , 3 , l} = [ \begin{matrix}{k}_{l , 0}^{( 1 )} & {k}_{l , 1}^{( 1 )}\end{matrix} ] , from {k}_{l , p}^{( 1 )}$$

to amplitude coefficient

$${p}_{l , p}^{( 1 )} ,$$

or based on a mapping table of quantization per non-zero coefficient for amplitude coefficient indicators

$${i}_{2 , 4 , l} = [ {k}_{l , 0}^{( 2 )} … {k}_{l , {M}_{v} - 1}^{( 2 )} ] , from {k}_{l , i , f}^{( 2 )}$$

to amplitude coefficient

$${p}_{l , i , f}^{( 2 )} .$$

24. The apparatus of item 23, wherein the mapping table for i_{2,3,l} is an enhanced mapping table comprising eight entries, or the mapping table for i_{2,4,l} is an enhanced mapping table comprising four entries.

25. The apparatus of item 20, wherein the amplitude coefficients include value ‘0’ for per polarization amplitude coefficient

$${p}_{l , p}^{( 1 )}$$

for a transmitting-receiving identity with amplitude smaller than a predefined value.

26. The apparatus of item 25, wherein the CSI report comprises, in CSI part 1, a number of non-zero amplitude coefficients across layers and across transmitting-receiving identities, having ┌log₂(8N)┐ number of bits, where N is configured number of transmitting-receiving identities for CJT.

27. The apparatus of item 25, wherein the CSI report comprises, in CSI part 1 or CSI part 2, a bitmap per layer to indicate non-zero amplitude coefficients for two polarizations of each transmitting-receiving identity, having (2N−1) number of bits per layer, where N is configured number of transmitting-receiving identities for CJT.

28. The apparatus of item 20, wherein the amplitude coefficients comprise amplitude coefficients of non-zero elements that are indicated based on the amplitude of the strongest coefficient per transmitting-receiving identity.

29. The apparatus of item 28, wherein, upon determining that a quantization value for amplitude coefficient reporting is smaller than a predefined value, corresponding indication states or indication bits in the CSI report are set to predefined values.

30. The apparatus of item 20, wherein the phase coefficients are quantized with two different quantization precisions.

31. The apparatus of item 30, wherein the two different quantization precisions are precisions of 16-PSK quantization and 8-PSK quantization.

32. The apparatus of item 30, wherein the phase coefficients of one or more first transmitting-receiving identities are quantized with a higher precision; and the phase coefficients of one or more second transmitting-receiving identities are quantized with a lower precision.

33. The apparatus of item 32, wherein the first transmitting-receiving identities are determined based on RSRP values, or the strongest amplitude coefficient values of the transmitting-receiving identities, or UE reported transmitting-receiving identity indexes for the first transmitting-receiving identities.

34. The apparatus of item 33, wherein a number of the first transmitting-receiving identities is set as a predefined value, or determined based on a preconfigured threshold, or UE reported value.

35. The apparatus of item 30, wherein the phase coefficients comprise a first coefficient set and a second coefficient set; non-zero elements in the first coefficient set have larger amplitude values than non-zero elements in the second coefficient set; and non-zero elements of the two coefficient sets are quantized with different precisions.

36. The apparatus of item 36, wherein the first coefficient set includes

$${K}_{0} = {δ}_{1} ⌈ β 2 {\sum }_{i = 1}^{N} {L}_{i} {M}_{1} ⌉$$

per layer, and/or

$$2 {K}_{0} = 2 {δ}_{2} ⌈ β2 {\sum }_{i = 1}^{N} {L}_{i} {M}_{1} ⌉$$

across layers, number of coefficients, where δ₁ and δ₂ are predefined or high layer configured per-layer ratio and cross-layer ratio, respectively.

37. The apparatus of item 36, wherein the first coefficient set includes a number of coefficients per layer and/or across layers, being a predefined fixed number or predefined numbers y₁, y₂ determined based on selected beam number

$$\tilde{L} = {\sum }_{i = 1}^{N} {L}_{i} ,$$

where Lᵢ is selected beam number for i^{th} transmitting-receiving identity.

38. The apparatus of item 38, wherein the configured value y₁ is the same as \tilde{L} with an assumption of M₁=2, β=¼ and y₂=2y₁.

In a further aspect, some items as examples of the disclosure concerning a method of UE may be summarized as follows:

39. A method, comprising:
receiving, by a receiver, a configuration signalling for a Channel State Information (CSI) report based on a codebook for coherent joint transmission (CJT) with a plurality of transmitting-receiving identities; and
transmitting, by a transmitter, the CSI report with amplitude coefficients and/or phase coefficients based on the codebook.

40. The method of item 39, wherein the amplitude coefficients comprise a strongest coefficient, per layer or across layers, for each transmitting-receiving identity.

41. The method of item 40, wherein the amplitude coefficients comprise a reference coefficient for a strongest amplitude among the transmitting-receiving identities, and the strongest coefficient for each transmitting-receiving identity is quantized based on a differential value with respect to the reference coefficient.

42. The method of item 41, wherein the differential value is determined based on a mapping table of quantization per polarization for amplitude coefficient indicators

$${i}_{2 , 3 , l} = [ {k}_{l , 0}^{( 1 )} {k}_{l , 1}^{( 1 )} ] , from {k}_{l , p}^{( 1 )}$$

to amplitude coefficient

$${p}_{l , p}^{( 1 )} ,$$

or based on a mapping table of quantization per non-zero coefficient for amplitude coefficient indicators

$${i}_{2 , 4 , l} = [ {k}_{l , 0}^{( 2 )} … {k}_{l , {M}_{υ} - 1}^{( 2 )} ] , from {k}_{l , i , f}^{( 2 )}$$

to amplitude coefficient

$${p}_{l , i , f}^{( 2 )} .$$

43. The method of item 42, wherein the mapping table for i_{2,3,l} is an enhanced mapping table comprising eight entries, or the mapping table for i_{2,4,l} is an enhanced mapping table comprising four entries.

44. The method of item 39, wherein the amplitude coefficients include value ‘0’ for per polarization amplitude coefficient

$${p}_{l , p}^{( 1 )}$$

for a transmitting-receiving identity with amplitude smaller than a predefined value.

45. The method of item 44, wherein the CSI report comprises, in CSI part 1, a number of non-zero amplitude coefficients across layers and across transmitting-receiving identities, having ┌log₂(8N)┐ number of bits, where N is configured number of transmitting-receiving identities for CJT.

46. The method of item 44, wherein the CSI report comprises, in CSI part 1 or CSI part 2, a bitmap per layer to indicate non-zero amplitude coefficients for two polarizations of each transmitting-receiving identity, having (2N−1) number of bits per layer, where N is configured number of transmitting-receiving identities for CJT.

47. The method of item 39, wherein the amplitude coefficients comprise amplitude coefficients of non-zero elements that are indicated based on the amplitude of the strongest coefficient per transmitting-receiving identity.

48. The method of item 47, wherein, upon determining that a quantization value for amplitude coefficient reporting is smaller than a predefined value, corresponding indication states or indication bits in the CSI report are set to predefined values.

49. The method of item 39, wherein the phase coefficients are quantized with two different quantization precisions.

50. The method of item 49, wherein the two different quantization precisions are precisions of 16-PSK quantization and 8-PSK quantization.

51. The method of item 49, wherein the phase coefficients of one or more first transmitting-receiving identities are quantized with a higher precision; and the phase coefficients of one or more second transmitting-receiving identities are quantized with a lower precision.

52. The method of item 51, wherein the first transmitting-receiving identities are determined based on RSRP values, or the strongest amplitude coefficient values of the transmitting-receiving identities, or UE reported transmitting-receiving identity indexes for the first transmitting-receiving identities.

53. The method of item 52, wherein a number of the first transmitting-receiving identities is set as a predefined value, or determined based on a preconfigured threshold, or UE reported value.

54. The method of item 49, wherein the phase coefficients comprise a first coefficient set and a second coefficient set; non-zero elements in the first coefficient set have larger amplitude values than non-zero elements in the second coefficient set; and non-zero elements of the two coefficient sets are quantized with different precisions.

55. The method of item 55, wherein the first coefficient set includes

$${K}_{0} = {δ}_{1} ⌈ β2 {\sum }_{i = 1}^{N} {L}_{i} {M}_{1} ⌉$$

per layer, and/or

$$2 {K}_{0} = 2 {δ}_{2} ⌈ β2 {\sum }_{i = 1}^{N} {L}_{i} {M}_{1} ⌉$$

across layers, number of coefficients, where δ₁ and δ₂ are predefined or high layer configured per-layer ratio and cross-layer ratio, respectively.

56. The method of item 55, wherein the first coefficient set includes a number of coefficients per layer and/or across layers, being a predefined fixed number or predefined numbers y₁, y₂ determined based on selected beam number

$$\tilde{L} = {\sum }_{i = 1}^{N} {L}_{i} ,$$

where Lᵢ is selected beam number for i^{th} transmitting-receiving identity.

57. The method of item 57, wherein the configured value y₁ is the same as \tilde{L} with an assumption of M₁=2, β=¼ and y₂=2y₁.

In a yet further aspect, some items as examples of the disclosure concerning a method of gNB may be summarized as follows:

58. A method, comprising:
transmitting, by a transmitter, a configuration signalling for a Channel State Information (CSI) report based on a codebook for coherent joint transmission (CJT) with a plurality of transmitting-receiving identities; and
receiving, by a receiver, the CSI report with amplitude coefficients and/or phase coefficients based on the codebook.

59. The method of item 58, wherein the amplitude coefficients comprise a strongest coefficient, per layer or across layers, for each transmitting-receiving identity.

60. The method of item 59, wherein the amplitude coefficients comprise a reference coefficient for a strongest amplitude among the transmitting-receiving identities, and the strongest coefficient for each transmitting-receiving identity is quantized based on a differential value with respect to the reference coefficient.

61. The method of item 60, wherein the differential value is determined based on a mapping table of quantization per polarization for amplitude coefficient indicators

$${i}_{2 , 3 , l} = [ {k}_{l , 0}^{( 1 )} {k}_{l , 1}^{( 1 )} ] , from {k}_{l , p}^{( 1 )}$$

to amplitude coefficient

$${p}_{l , p}^{( 1 )} ,$$

or based on a mapping table of quantization per non-zero coefficient for amplitude coefficient indicators

$${i}_{2 , 4 , l} = [ {k}_{l , 0}^{( 2 )} … {k}_{l , {M}_{υ} - 1}^{( 2 )} ] , from {k}_{l , i , f}^{( 2 )}$$

to amplitude coefficient

$${p}_{l , i , f}^{( 2 )} .$$

62. The method of item 61, wherein the mapping table for i_{2,3,l} is an enhanced mapping table comprising eight entries, or the mapping table for i_{2,4,l} is an enhanced mapping table comprising four entries.

63. The method of item 58, wherein the amplitude coefficients include value ‘0’ for per polarization amplitude coefficient

$${p}_{l , p}^{( 1 )}$$

for a transmitting-receiving identity with amplitude smaller than a predefined value.

64. The method of item 63, wherein the CSI report comprises, in CSI part 1, a number of non-zero amplitude coefficients across layers and across transmitting-receiving identities, having ┌log₂(8N)┐ number of bits, where N is configured number of transmitting-receiving identities for CJT.

65. The method of item 63, wherein the CSI report comprises, in CSI part 1 or CSI part 2, a bitmap per layer to indicate non-zero amplitude coefficients for two polarizations of each transmitting-receiving identity, having (2N−1) number of bits per layer, where N is configured number of transmitting-receiving identities for CJT.

66. The method of item 58, wherein the amplitude coefficients comprise amplitude coefficients of non-zero elements that are indicated based on the amplitude of the strongest coefficient per transmitting-receiving identity.

67. The method of item 66, wherein, upon determining that a quantization value for amplitude coefficient reporting is smaller than a predefined value, corresponding indication states or indication bits in the CSI report are set to predefined values.

68. The method of item 58, wherein the phase coefficients are quantized with two different quantization precisions.

69. The method of item 68, wherein the two different quantization precisions are precisions of 16-PSK quantization and 8-PSK quantization.

70. The method of item 68, wherein the phase coefficients of one or more first transmitting-receiving identities are quantized with a higher precision; and the phase coefficients of one or more second transmitting-receiving identities are quantized with a lower precision.

71. The method of item 70, wherein the first transmitting-receiving identities are determined based on RSRP values, or the strongest amplitude coefficient values of the transmitting-receiving identities, or UE reported transmitting-receiving identity indexes for the first transmitting-receiving identities.

72. The method of item 71, wherein a number of the first transmitting-receiving identities is set as a predefined value, or determined based on a preconfigured threshold, or UE reported value.

73. The method of item 68, wherein the phase coefficients comprise a first coefficient set and a second coefficient set; non-zero elements in the first coefficient set have larger amplitude values than non-zero elements in the second coefficient set; and non-zero elements of the two coefficient sets are quantized with different precisions.

74. The method of item 74, wherein the first coefficient set includes K₀=

$${δ}_{1} ⌈ β2 {\sum }_{i = 1}^{N} {L}_{i} {M}_{1} ⌉$$

per layer, and/or

$$2 {K}_{0} = 2 {δ}_{2} ⌈ β 2 {\sum }_{i = 1}^{N} {L}_{i} {M}_{1} ⌉$$

across layers, number of coefficients, where δ₁ and δ₂ are predefined or high layer configured per-layer ratio and cross-layer ratio, respectively.

75. The method of item 74, wherein the first coefficient set includes a number of coefficients per layer and/or across layers, being a predefined fixed number or predefined numbers y₁, y₂ determined based on selected beam number

$$\tilde{L} = {\sum }_{i = 1}^{N} {L}_{i} ,$$

where Lᵢ is selected beam number for i^{th} transmitting-receiving identity.

76. The method of item 76, wherein the configured value y₁ is the same as \tilde{L} with an assumption of M₁=2, β=¼ and y₂=2y₁.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and operable to cause the UE to:
receive a configuration for a Channel State Information (CSI) report based on a codebook for coherent joint transmission (CJT) with transmitting-receiving identities; and
transmit the CSI report with one or more of amplitude coefficients or phase coefficients based at least in part on the codebook.

2. The UE of claim 1, wherein the amplitude coefficients comprise a strongest coefficient, per layer or across layers, for each transmitting-receiving identity; and
the amplitude coefficients comprise a reference coefficient for a strongest amplitude among the transmitting-receiving identities, and the strongest coefficient for each transmitting-receiving identity is quantized based on a differential value with respect to the reference coefficient.

3. The UE of claim 2, wherein the differential value is determined based on a mapping table of quantization per polarization for amplitude coefficient indicators
$${i}_{2 , 3 , l} = [ {k}_{l , 0}^{( 1 )} {k}_{l , 1}^{( 1 )} ] , from {k}_{l {,}_{P}}^{( 1 )}$$
to amplitude coefficient
$${p}_{l {,}_{P}}^{( 1 )} ,$$
or based on a mapping table of quantization per non-zero coefficient for amplitude coefficient indicators
$${i}_{2 , 4 , l} = [ {k}_{l , 0}^{( 2 )} … {k}_{l , {M}_{v} - 1}^{( 2 )} ] , from {k}_{l , i , f}^{( 2 )}$$
to amplitude coefficient
$${p}_{l , i , f}^{( 2 )} ;$$
or
the mapping table for i_{2,3,l} is an enhanced mapping table comprising eight entries, or the mapping table for i_{2,4,l} is an enhanced mapping table comprising four entries.

4. The UE of claim 1, wherein the amplitude coefficients include value ‘0’ for per polarization amplitude coefficient
$${p}_{l {,}_{P}}^{( 1 )}$$
for a transmitting-receiving identity with amplitude smaller than a predefined value.

5. The UE of claim 4, wherein the CSI report comprises, in CSI part 1, a number of non-zero amplitude coefficients across layers and across transmitting-receiving identities; or
wherein the CSI report comprises, in CSI part 1 or CSI part 2, a bitmap per layer to indicate non-zero amplitude coefficients for two polarizations of each transmitting-receiving identity.

6. The UE of claim 1, wherein the amplitude coefficients comprise amplitude coefficients of non-zero elements that are indicated based on an amplitude of a strongest coefficient per transmitting-receiving identity.

7. The UE of claim 6, wherein, upon determining that a quantization value for amplitude coefficient reporting is smaller than a predefined value, corresponding indication states or indication bits in the CSI report are set to predefined values.

8. The UE of claim 1, wherein the phase coefficients of one or more first transmitting-receiving identities are quantized with a higher precision; and
the phase coefficients of one or more second transmitting-receiving identities are quantized with a lower precision.

9. The UE of claim 8, wherein the one or more first transmitting-receiving identities are determined based on Reference Signal Received Power (RSRP) values, or strongest amplitude coefficient values of the transmitting-receiving identities, or UE reported transmitting-receiving identity indexes for the one or more first transmitting-receiving identities.

10. The UE of claim 9, wherein a number of the one or more first transmitting-receiving identities is set as a predefined value, or determined based on a preconfigured threshold, or UE reported value.

11. The UE of claim 1, wherein the phase coefficients comprise a first coefficient set and a second coefficient set; non-zero elements in the first coefficient set have larger amplitude values than non-zero elements in the second coefficient set; and non-zero elements of the first coefficient set and the second coefficient set are quantized with different precisions.

12. The UE of claim 11, wherein the first coefficient set includes
$${K}_{0} = {δ}_{1} ⌈ β2 {\sum }_{i = 1}^{N} {L}_{i} {M}_{1} ⌉$$
per layer, and/or
$$2 {K}_{0} = 2 {δ}_{2} ⌈ β2 {\sum }_{i = 1}^{N} {L}_{i} {M}_{1} ⌉$$
across layers, number of coefficients, where δ₁ and δ₂ are predefined or high layer configured per-layer ratio and cross-layer ratio, respectively; or
wherein the first coefficient set includes a number of coefficients per layer and/or across layers, being a predefined fixed number or predefined numbers y₁, y₂ determined based on selected beam number
$$\tilde{L} = {\sum }_{i = 1}^{N} {L}_{i} ,$$
where Lᵢ is selected beam number for i^{th} transmitting-receiving identity.

13. The UE of claim 8, wherein different quantization precisions are precisions of 16-PSK quantization and 8-PSK quantization.

14. A network equipment (NE) for wireless communication, comprising:
at least one memory; and
at least one processor coupled with the at least one memory and operable to cause the NE to:
transmit a configuration for a Channel State Information (CSI) report based on a codebook for coherent joint transmission (CJT) with transmitting-receiving identities; and
receive the CSI report with amplitude coefficients and/or phase coefficients based on the codebook.

15. A method performed by a user equipment (UE), comprising:
receiving a configuration for a Channel State Information (CSI) report based on a codebook for coherent joint transmission (CJT) with transmitting-receiving identities; and
transmitting the CSI report with amplitude coefficients and/or phase coefficients based on the codebook.

16. The method of claim 15, wherein the amplitude coefficients comprise a strongest coefficient, per layer or across layers, for each transmitting-receiving identity; and
the amplitude coefficients comprise a reference coefficient for a strongest amplitude among the transmitting-receiving identities, and the strongest coefficient for each transmitting-receiving identity is quantized based on a differential value with respect to the reference coefficient.

17. The method of claim 16, wherein the differential value is determined based on a mapping table of quantization per polarization for amplitude coefficient indicators
$${i}_{2 , 3 , l} = [ {k}_{l , 0}^{( 1 )} {k}_{l , 1}^{( 1 )} ] , from {k}_{l {,}_{P}}^{( 1 )}$$
to amplitude coefficient
$${p}_{l {,}_{P}}^{( 1 )} ,$$
or based on a mapping table of quantization per non-zero coefficient for amplitude coefficient indicators
$${i}_{2 , 4 , l} = [ {k}_{l , 0}^{( 2 )} … {k}_{l , {M}_{v} - 1}^{( 2 )} ] , from {k}_{l , i , f}^{( 2 )}$$
to amplitude coefficient
$${p}_{l , i , f}^{( 2 )} ;$$
or
the mapping table for i_{2,3,l} is an enhanced mapping table comprising eight entries, or the mapping table for i_{2,4,l} is an enhanced mapping table comprising four entries.

18. The method of claim 15, wherein the phase coefficients of one or more first transmitting-receiving identities are quantized with a higher precision; and
the phase coefficients of one or more second transmitting-receiving identities are quantized with a lower precision.

19. The method of claim 18, wherein the one or more first transmitting-receiving identities are determined based on Reference Signal Received Power (RSRP) values, or strongest amplitude coefficient values of the transmitting-receiving identities, or UE reported transmitting-receiving identity indexes for the one or more first transmitting-receiving identities.

20. A method performed by a network equipment (NE), comprising:
transmitting a configuration for a Channel State Information (CSI) report based on a codebook for coherent joint transmission (CJT) with transmitting-receiving identities; and
receiving the CSI report with amplitude coefficients and/or phase coefficients based on the codebook.
